(19) United States
(12) Patent Application Publication
(10) Pub. No.: US 2016/0133938 A1
(43) Pub. Date: May 12, 2016

(54) NOVEL COMPOSITE CONDUCTIVE MATERIAL

(71) Applicants: Gordon CHIU, Summit, NJ (US); GRAFOID, INC., Ottawa (CA); INSTITUT DE RECHERCHE EN ÉLECTRICITÉ D'HYDROQUÉBEC, Varennes (CA)

(72) Inventors: Gordon CHIU, Summit, NJ (US); Karim ZAGHIB, Varennes, Quebec (CA); Abdelbast GUERFI, Varennes, Quebec (CA); Amelie FORAND, Varennes, Quebec (CA)

(21) Appl. No.: 14/904,289

(22) PCT Filed: Jul. 9, 2014
(86) PCT No.: PCT/IB2014/062987

§ 371 Date: Jan. 11, 2016

(30) Foreign Application Priority Data
Jul. 10, 2013 (CA) 2,820,227

(51) Int. Cl. H01M 4/62; H01M 4/58; H01M 10/052; C01B 31/04

(52) U.S. Cl. CPC H01M 4/625; C01B 31/0484; H01M 4/5825; H01M 10/052; H01M 2004/028

(57) ABSTRACT

A novel active material comprising graphene-fibrous carbon composite and a method of making it is provided. The composite is highly uniform and conductive. The composite comprises graphene or nanoporous graphene and fibrous carbon, preferably vapor grown carbon fibers (VGCF) and optionally a lithiummetalphosphate (LMP), preferably lithiumferrophosphate or lithiummanganesephosphate.

### PRIORITY

This application claims priority of Canadian patent application number CA2820227 filed on Jul. 10 2013, the contents of which is incorporated herein by reference.

### FIELD OF THE INVENTION

The present invention relates to composite conductive materials and methods for preparing same.

### BACKGROUND OF THE INVENTION

Graphene is a material composed of pure carbon, with atoms arranged in a regular hexagonal pattern. Graphene can be described as a one-atom thick layer of the mineral graphite. One of the most remarkable properties of graphene is its high conductivity—thousands of times higher than copper. Another of graphene's stand-out properties is its inherent strength. Due to the strength of its 0.142 Nm-long carbon bonds, graphene is the strongest material ever discovered. Not only is graphene extraordinarily strong, it is also very light at 0.77 milligrams per square meter. Graphene's many desirable properties make it a useful material for many applications.

Various conductive materials and methods to prepare them are known in the art.

US Publication No. 2010/0327223 discloses a cathode material comprising particles having a lithium metal phosphate core and a thin pyrolytic carbon deposit.

WO2010/012076 discloses a composite material useful as the cathode material for batteries comprising carbon fibers and complex oxide particles, where the carbon fibers and the complex oxide particles have a carbon coating on at least part of their surface and wherein the carbon coating is a non powdery coating.

U.S. Pat. No. 6,855,273 discloses a method for preparing an electrode material by heat treatment, in a controlled atmosphere, of a carbonaceous precursor in the presence of a complex oxide or its precursor. The obtained material with complex oxide particles with carbon coating has a substantially increased conductivity as compared to non-coated oxide particles.

WO2004/044289 discloses a composite material obtained by mixing vapor grown carbon fibers with a matrix material, where the matrix material is a resin, a ceramic or a metal to enhance thermal and electrical conductivity of the material.

US Publication No. 2003/0198588 discloses vapor grown carbon fibers comprising an inorganic transition metallic compound.

US Publication No. 2010/0055465 discloses a method of forming a carbon-carbon composite where vapor grown carbon fibers, carbon nanofibers, and optionally nano-graphene platelets are reformed into a composite.

U.S. Pat. No. 7,354,988 discloses a method to make a conductive composition comprising blending a polymer precursor with a carbon nanotube composition, where the carbon nanotube composition may comprise vapor grown carbon fibers. U.S. Pat. No. 8,404,070 discloses a graphene sheet-carbon nanotube film composite.

Thus, there are several publications disclosing various conductive compositions and compositions with improved characteristics. However, there is a continuous need in various industries for novel composite materials having high conductivity, uniformity and having low production cost.

### SUMMARY OF THE INVENTION

The invention provides an active, uniform, conductive material comprising a composite of graphene and fibrous carbon. Preferably the fibrous carbon is vapor grown carbon fibers (VGCF). The composition of this disclosure comprises graphene forming boat like structures, and the VGCF fibers are located inside these boat like graphene structures. The structure is made by co grinding graphene and fibrous carbon to obtain a partially ordered mixture and submitting the mixture to mechanofusion. Optionally lithium metal phosphate (LMP) may be included in the composite. The LMP particles locate also inside the graphene boats. Other embodiments of the invention include nanoporoius-graphene oxide-LMP-material.

The present invention provides a novel active composite material and a method to make it.

The present invention provides a highly uniform conductive composite.

The present invention provides a cathode material comprising graphene, fibrous carbon and lithium metal phosphate (LMP) particles.

It is an object of this invention to provide a composite conductive material comprising graphene and fibrous carbon.

It is another object of this invention to provide a cathode material comprising graphene, fibrous carbon and lithium metal phosphate.

It is yet another object of this invention to provide nanoporous graphene oxide-LMP material. More specifically the nanoporous graphene-LMP material may be nanoporous Amphioxide™-LMP, where Amphioxide is oxidized from few layered graphene Mesgraf™).

It is a yet another object of this invention to provide a method for preparing a composite conductive material, said method comprising the steps of: providing graphene; providing fibrous carbon; co-grinding graphene and fibrous carbon in a high speed stirred mixer creating a partially ordered mixture; and subjecting the partially ordered mixture to mechanofusion.

Still another object of this invention is to provide a method of preparing a cathode material, said method comprising the steps of: providing particles of at least one lithium metal phosphate; providing fibrous carbon; providing graphene; co-grinding graphene, fibrous carbon and LMP particles in a high speed stirred mixer creating a partially ordered mixture; and subjecting the partially ordered mixture to mechanofusion.

### BRIEF DESCRIPTION OF THE DRAWINGS

FIGS. 1, 2 and 3 are SEM micrographs of Graphene-LMP-VGCF mixture. Magnification 150× in FIG. 1, 7000× in FIGS. 2 and 3.

FIGS. 4, and 5 are SEM micrographs of Graphene-LMP-VGCF mixture after annealing at 1000° C. Magnification 400× in FIG. 4 and 1000× in FIG. 5.

FIG. 6 shows discharge capacity of a coin-cell (½ cell) containing the material. The capacity is shown for both laminated and not laminated material.

FIG. 7 shows impedance results before and after formation of the composite, for both laminated as well as not laminated material comprising LMP, Graphene, VGCF and PVD in and annealed at 1000 C. The data shows high capacity, high rate and high columbic efficiency (100%). Specifically FIG. 7 shows the impedance results before and after formation of the composite.

FIGS. 8, 9, 10, 11 and 12 are SEM micrographs of Graphene-VGCF mixture after annealing at 1000° C. Magnification 1000× in FIG. 8; 1100× in FIG. 9; 400× in FIG. 10; 1300× in FIG. 11 and 11,000× in FIG. 12.

FIG. 13 shows Raman spectra of graphite, graphene obtained by Hummers method and of Mesograf™. Notably, Mesograf™ has no or only minimal D-peak.

### DETAILED DESCRIPTION OF THE INVENTION

As used herein, the term graphene means graphene in its pure form or modified in any way, including but not limited to graphene nanostripes, graphene oxide, bi-layer graphene or few layered graphene, such as Mesograf™. In addition, the methods of the present invention may also apply to chemically modified graphene, i.e., modified with carbodiimide treatments, or sulfuric and nitric acid, etc.

As used herein, Mesograf™ refers specifically to graphene containing few layers (for example 1-3 layers), and obtained from Grafoid Inc. (Ottawa, Canada). The properties of Mesograf™ is the preferred starting material to make the composites described in this application, and the processes related thereto. Graphene oxide made of Mesograf is called Amphioxide™. International patent application publication WO2013/089642 for National University of Singapore which is incorporated herein by reference discloses a process for forming expanded hexagonal layered minerals and derivatives from graphite raw ore using electrochemical charging. Mesograf™ is large area few layered graphene sheets manufactured by the method disclosed in WO2013/089642. The process comprises immersing at least a portion of graphite ore into a slurry comprising metal salt and organic solvent. The rock is electrochemically charged by incorporation the rock into at least one electrode and performing electrolysis through the slurry using the electrode and thereby introducing the organic solvent and ions from the metal salt from the slurry into the interlayer spacing of the graphite rock to form 1^{st}-stage charged graphite mineral that exfoliates from the graphite rock. The process further includes expanding the 1^{st} stage charged graphite by applying an expanding force to increase the interlayer spacing between the atomic layers. As a result few layered graphene sheets are obtained by one step process from graphite ore. The sheets have an area of 300-500 μm² in average.

By fibrous carbon it is meant carbon fibers consisting of fiber filaments having a diameter of 5 to 500 nm and length-to-diameter ratio of 20 to 1000.

By Vapor Grown Carbon Fibers (VGCF) it is meant fibrous carbon obtained by spraying a solution containing a carbon source and a transition metal into a reaction zone and subjecting the carbon source to thermal decomposition, heating the carbon fibers thus obtained in a non-oxidative atmosphere at a temperature between 1500° C. and 8000° C., and further heating the carbon fibers in a non-oxidative atmosphere at 2000° C. to 3000° C.

By mechanofusion it is meant a dry process performed in a mechanofusion reactor comprising a cylindrical chamber which rotates at high speed and which is equipped inside with compression tools and blades. Rotation speed is generally higher than 100 rpm. The particles are introduced into the chamber and upon rotation of the chamber; the particles are pressed together and to the chamber walls via centripetal force, and by the compression tools and blades. Mechanochemical surface fusion of the components being mixed occurs as a result of the strong mechanical forces acting on the particles.

### DETAILED DESCRIPTION OF THE INVENTION

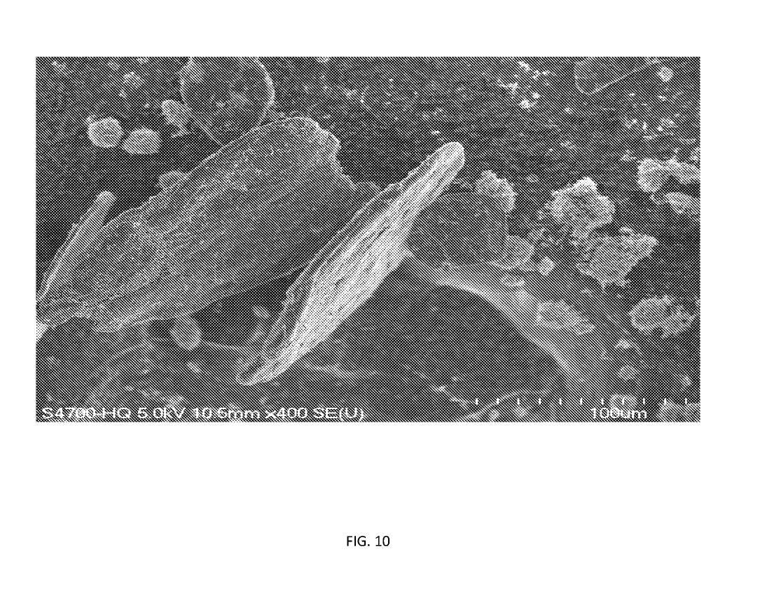

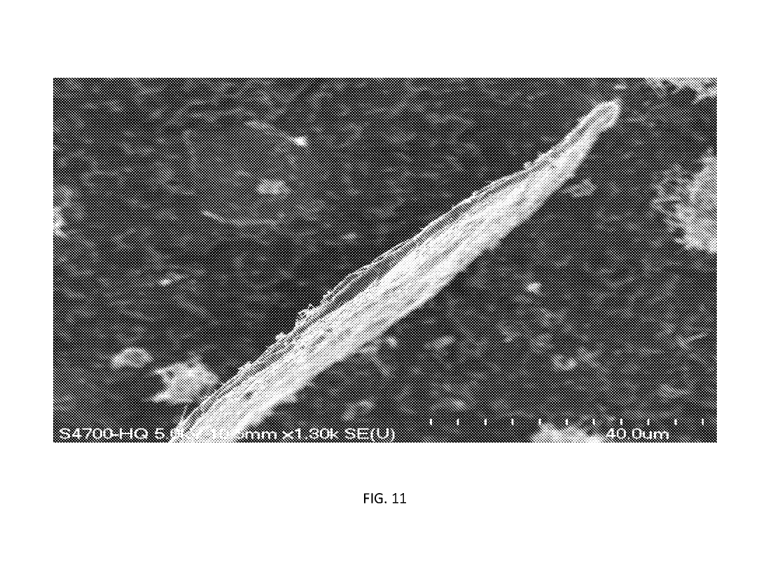

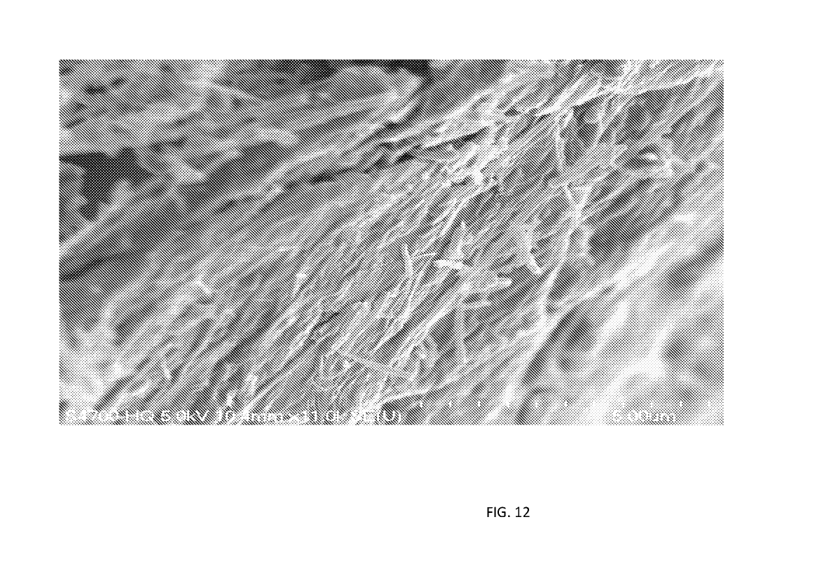

According to one embodiment an active and conductive composite of graphene and vapor grown carbon fibers (VGCF) is provided by using mechanofusion. A preferred ratio of graphene to VGCF is 50:50 (weight), however, other ratios may also be used, such as but not limited to 40:60, or 60:40. According to this embodiment a mixture of VGCF and graphene is obtained by mixing them in a high-speed-stirred mixer for a time period depending on other conditions. The mixing provides a partially ordered mixture that is then subjected to mechanofusion. According to a preferred embodiment the mechanofusion step takes about five minutes. During the mechanofusion the graphene forms boat like structures and the VGCF fibers will be located “inside” the boat structure. FIGS. 10, 11 and 12 show such boat like structures. The VGCF fibers cannot be seen in the figures, because they are inside the boat structure. The composite according to this disclosure has an extraordinary uniform structure. More or less all carbon fibers are found inside the graphene boats.

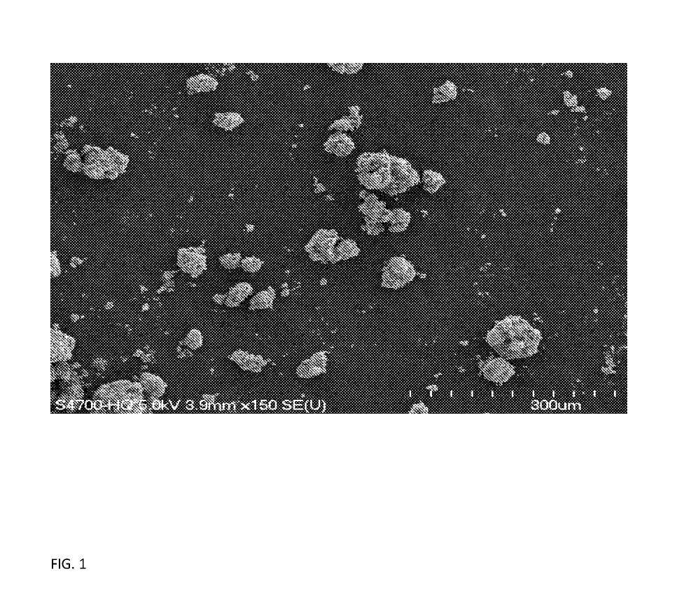

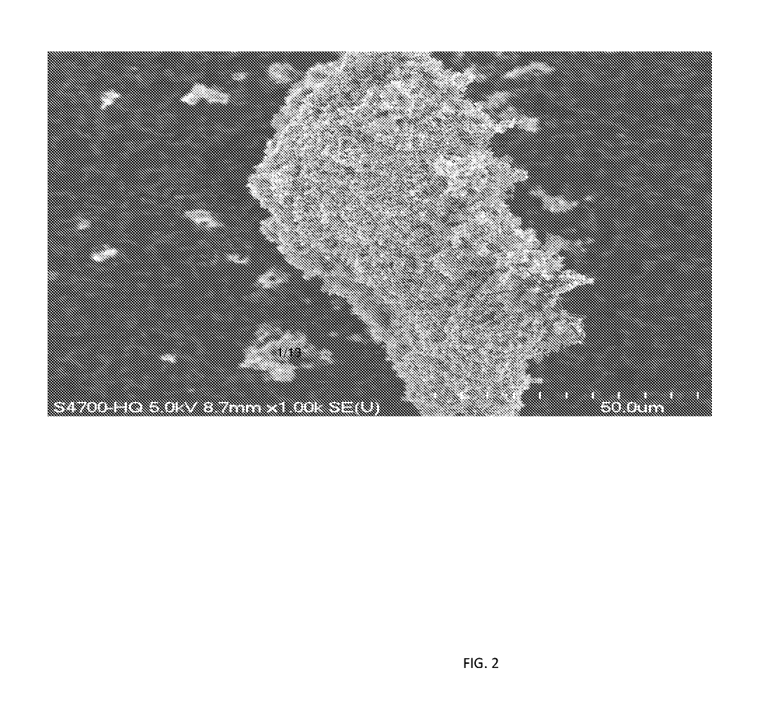

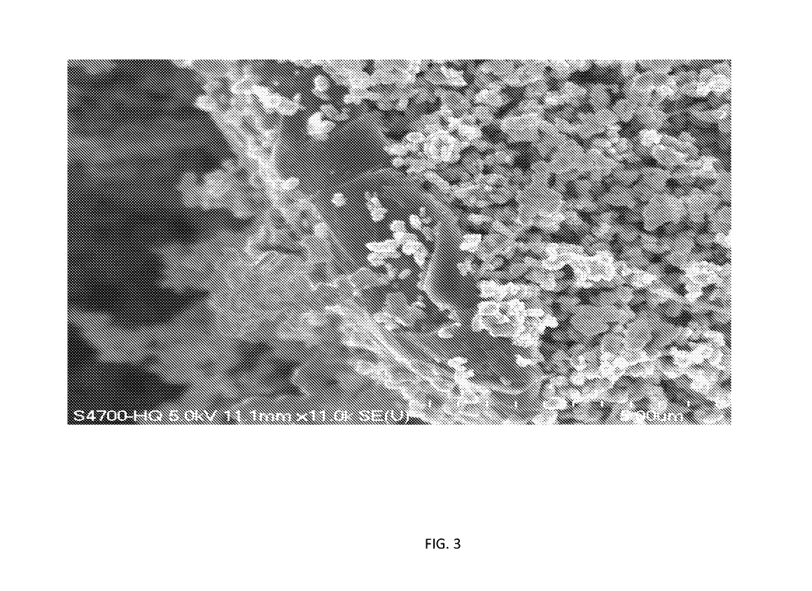

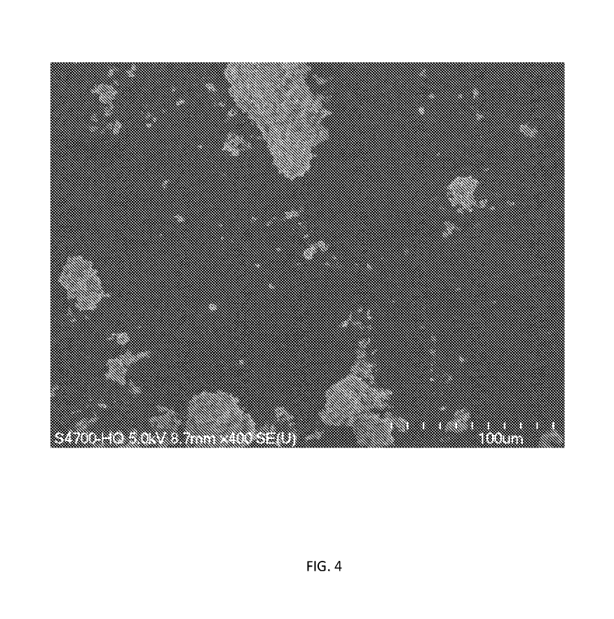

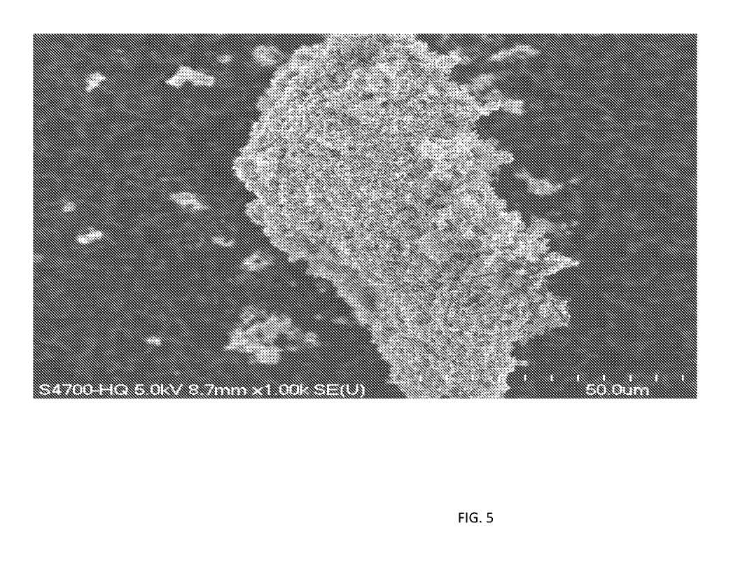

In order to prepare a cathode material with improved conductivity for lithium batteries a lithium metal phosphate (LMP) is added into the compositions. LMP is added into the initial grinding process and a mixture of VGCF, graphene and LMP is obtained by mixing them in a high-speed-stirred mixer for a time period the length of which depends on other conditions. The mixing provides a partially ordered mixture that is then subjected to mechanofusion. According to a preferred embodiment the mechanofusion step takes about five minutes. During the mechanofusion the graphene forms boat like structures and the VGCF fibers as well as the LMP particles will be located “inside” the boat structure. The composite according to this disclosure has an extraordinary uniform structure: FIGS. 1 and 2 show almost no graphene without LMP agglomeration. The fibrous carbon in the composite material creates a multi-channel structure forming network conductivity between the graphene and LMP particles. The composition comprises 90-95 parts (weight) of graphene, 1-5 parts of VGCF and 1-5 parts of LMP. According to a preferred embodiment the ratio of graphene:VGCF:LMP is 94:3:3 (by weight). In case a binder is used in the composition the final composition contains approximately 95% of the mixture of LMP-Graphene-VGCF and approximately 5% of binder agent.

The lithium metal phosphate is preferably lithiumferrophosphate (LiFePO₄) or lithiummanganesephosphate (LiMnPO₄) or mixtures thereof. Mixtures of different lithium metal phosphates including LiFeSiO₄ and other additives can also be used in the composite. Polyvinylidinefluoride (PVDF) is a standard binding material used in composite electrodes, and can be used as a binder in composites of this invention as well. Other possible binders may be selected from polytetrafluorethylene (PTFE) and rubbers, such as styrene butadiene rubber (SBR) or natural rubber. PVDF may be used as a binder 3 to 10% of the total weight.

The fibrous carbon used to prepare the composite material of this invention consists of carbon fibers, wherein the carbon fiber consists of fiber filaments having a diameter of 5 to 500 nm and length-to-diameter ratio of 20 to 1000.

Carbon fibers may be obtained by a method comprising spraying a solution containing a carbon source and a transition metal into a reaction zone and subjecting the carbon source to thermal decomposition, heating the carbon fibers thus obtained in a non-oxidative atmosphere at a temperature between 1500° C. and 8000° C., and further heating the carbon fibers in a non-oxidative atmosphere at 2000° C. to 3000° C. The second heat treatment of the carbon, at 2000-3000° C., cleans the surface of the fibers and results in increasing the adhesion of the carbon fibers to the carbon coating of the complex oxide particles. The carbon fibers thus obtained are called Vapor Grown Carbon Fibers. More detailed information on the method for preparing vapor grown carbon fibers can be found in WO2004/044289.

Vapor Grown Carbon Fibers are also available from Showa Denko K.K. (Japan) under the trademark VGCF™. The fiber diameter of these fibers is about 150 nm, the fiber length is about 10 μm, the specific area is 13 m²/g, the electric conductivity is 0.1 mΩcm, and the purity is >99.95%.

Lithium metal phosphate (LMP) has been seen as an excellent candidate for cathode materials due to its intrinsic safety, low material cost and environment benign features. The covalently bounded oxygen atom in the phosphate polyanion eliminates the cathode instability against O₂ release observed in fully charged layered oxides. The drawbacks with Lithium metal phosphate cathode materials are their low electronic conductivity and slow electrode kinetics. To improve the conductivity of the lithium metal phosphate the particles may be coated with carbon coating. WO2010/0102076 teaches how carbon fibers and the complex oxide particles are mixed with organic carbon precursors and the composition is made by mechanofusion. Such coated LMP particles can also be used in the composite of this disclosure. Methods of making carbon coated LMP are described specifically in the examples of WO2010/0102076. The examples of the patent publication are incorporated herein by reference.

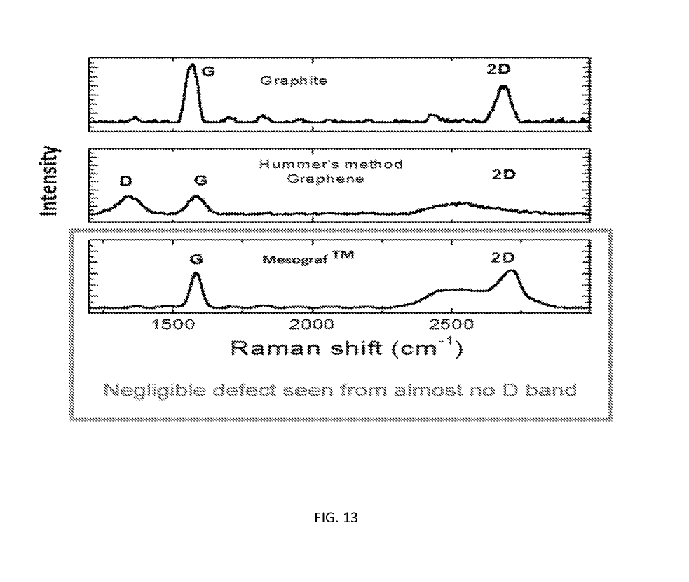

According to one preferred embodiment the starting material is Mesograf™ (Grafoid Inc., Ottawa, Canada), which is few layered graphene. Mesograf has extraordinary characters that make it superior to other starting materials. FIG. 13 shows Raman spectra of graphite, graphene obtained by Hummer's method and of Mesograf™. Unlike graphene made by Hummer's method, Mesograf™ does have almost no D band at all. Raman spectroscopy is commonly used to characterize graphene. The D-band is known as the disorder band or the defect band. The band is typically very weak in graphite. The intensity of the D-band is directly proportional to the level of the defects in the sample. As is shown in FIG. 13, the D-band of graphene made by Hummer's method is considerably more pronounced than in Mesograf™, which makes Mesograf™ a preferred starting material.

According to one preferred embodiment Mesograf™ is used to make nanoporous material, which is then fused to carbon coated LMP in mechanofusion process. Methods of making carbon coated LMP are described in the examples of WO2010/0102076. The examples of the patent publication are incorporated herein by reference.

The nanoporous material is made according to the following scheme:

Mesograf is mixed with sulfuric acid and then combined with a preformed mixture of Mn₂O₇ and rapidly heated to 50 degrees (notably this method avoids NaNO₃ or Nitric acid as used in modified or Hummers method, respectively). The resulting oxidized material is called Amphioxide™ Amphioxide is then refluxed in 5 M NaOH, filtered and washed with deionized water until pH is 8. Thereafter refluxed again in H₂SO₄. This creates a nanoporous Amphioxide which is then filtered, washed with deionized water until pH is 5-6 and then vacuum dried. Thus received nanoporous material is then mechanofused with carbon coated LMP to yield nanoporous Amphioxide-LMP. The nanoporous Amphioxide-LMP is a novel composite with interesting properties in energy storage with high BET/surface area.

The composite materials according to the present invention have an extraordinary uniform structure. The VGCF and LMP particles have high adhesion to the graphene as well as to the nanoporous Amphioxide and the composite materials obtained have a structure, where graphene or the nanoporous Amphioxide forms “a boat of carbon” and the VGCF and/or LMP particles are inside the boat. The process of making the material is fast and cost effective.

The composite materials obtained have high conductivity. The materials may be used for example in batteries, in conductive coatings and in capacitors. The composite material has other active features as well: among others it may have hydrophobic and icephobic characteristics. Table 1 below shows the capacity and coulombic efficiency of laminated or non laminated composite comprising LMP Graphene, VGCF (95% by weigh) and PVDF (5%).

| | Capacity 1 | Capacity 2 | | | |
|---|---|---|---|---|---|
| | (CH/DC) | (CH/DC) | C. Effi. 1 | C. Effi. 2 | C. Effi 3 |
| Coin-cell | (mAh/g) | mAh/g) | (%) | (%) | (%) |
| Not | 151/153 | 155/155 | 101.6 | 100.0 | 0.0 |
| Laminated | | | | | |
| Laminated | 152/154 | 155/155 | 101.7 | 100.0 | 0.00 |

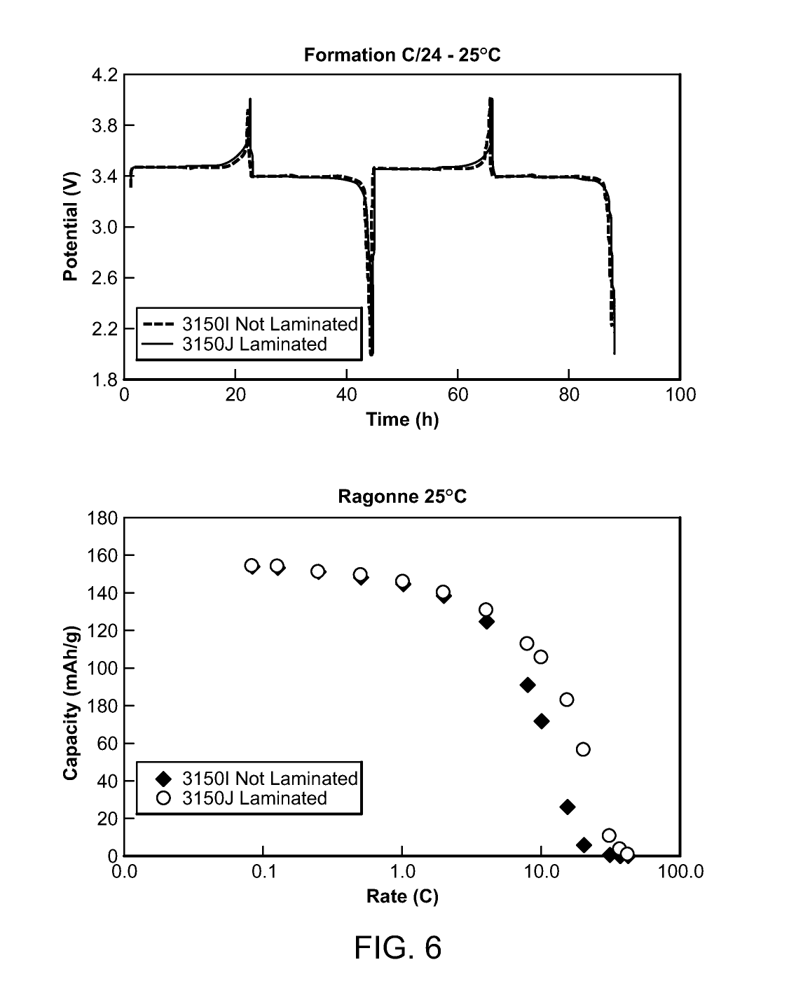

FIG. 6A shows the voltage profile as a function of charge-discharge time of the first and second cycles of material comprising LMP, Graphene, VGCF and PVDF annealed at 1000° C. 1M LiPF6+EC+DEC+2% VC. The density of the composition was 0.87 g/cc before lamination and 1.78 g/cc after lamination.

FIG. 6B shows the discharge capacity of a cell containing the material comprising LMP, Graphene, VGCF and PVDF annealed at 1000° C.

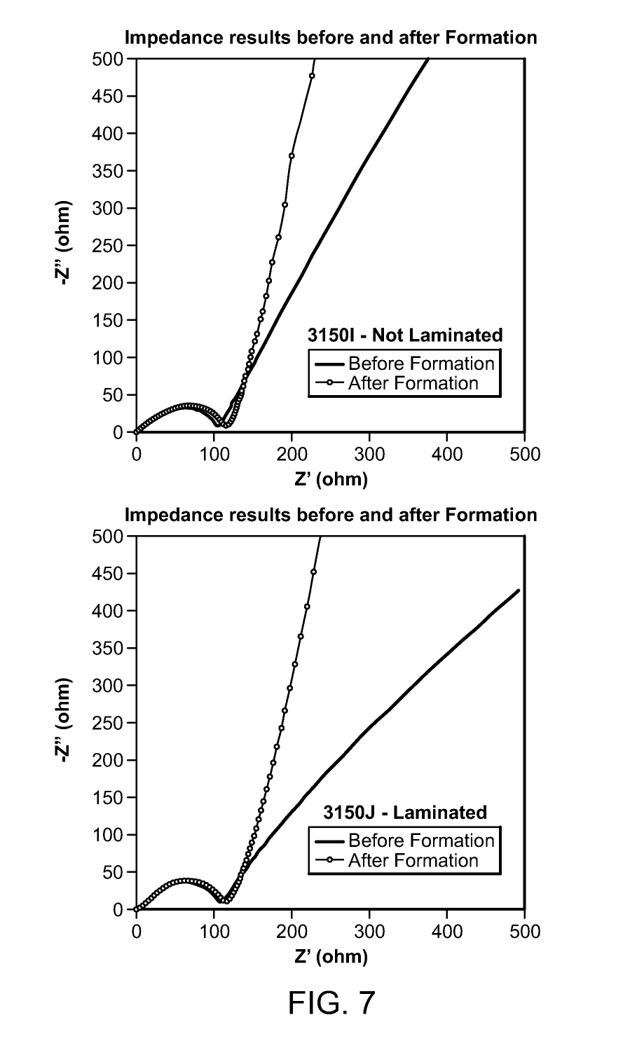

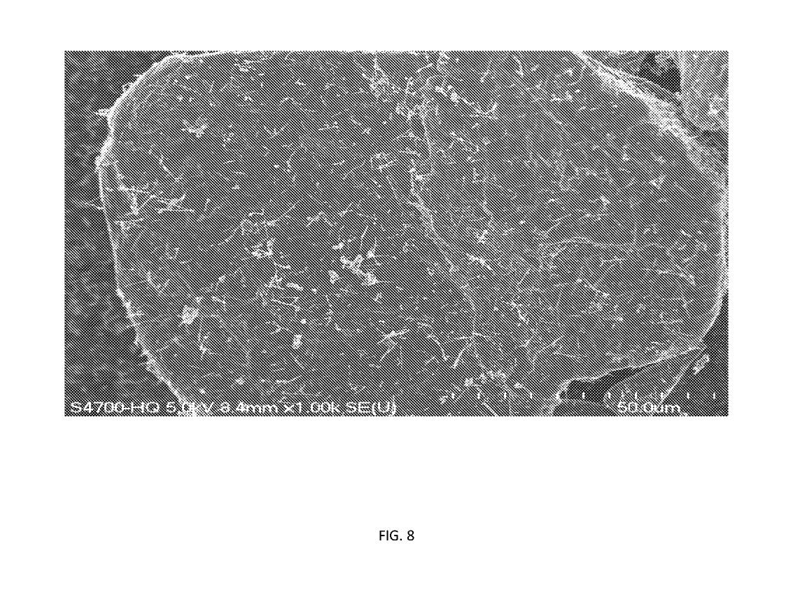

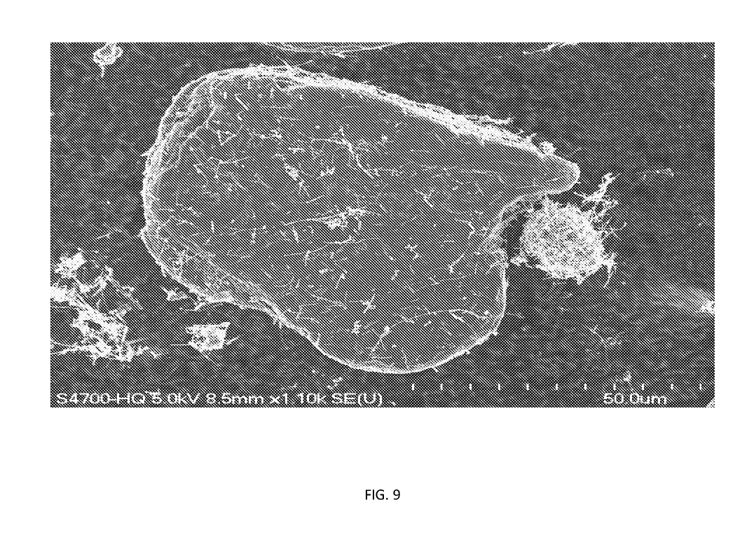

FIG. 7 shows the impedance results before and after formation of the composition. The composite comprises LMP, Graphene, VGCF (95% by weight) and PDVF (5% by weigh). The composite was annealed at 1000° C. Both a laminated and a not laminated composite was tested and the results are shown in two charts. The impedance are very close both of the electrodes and have high electronic conductivity.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An active material comprising graphene-fibrous carbon composite.

2. The material of claim 1, wherein the fibrous carbon is vapor grown carbon fibers (VGCF).

3. The material of claim 2, wherein the graphene forms boat like structures and the VGCF fibers are located inside the boat like graphene structures.

4. The material of claim 2, wherein the material is made by co grinding graphene and fibrous carbon to obtain a partially ordered mixture and submitting the mixture to mechanofusion.

5. The material of claim 3, wherein the ratio of graphene and VGCF is approximately 50:50.

6. The material of claim 1, wherein the material is uniform and conductive.

7. The material of claim 1, wherein the material is hydrophobic or ice-phobic.

8. A cathode material comprising graphene, fibrous carbon and lithium metal phosphate (LMP) particles.

9. The material of claim 8, wherein the fibrous carbon is VGCF.

10. The material of claim 9, wherein the graphene forms boat like structures, and the VGCF fibers and LMP-particles are located inside the boat like graphene structures.

11. The material of claim 10, wherein the material is made by co grinding graphene, fibrous carbon and LMP to obtain a partially ordered mixture and submitting the mixture to mechanofusion.

12. The material of claim 8, wherein the LMP is Lithiumferrophosphate or Lithiummanganasephosphate, or a combination thereof.

13. The material of claim 8, wherein the ratio of Graphene:LMF:VGCF is 93:3:3.

14. The material of claim 8, wherein the graphene is nanoporous Amphioxide™.

15. A method to prepare a uniform composite conductive material, said method comprising the steps of:
a) providing graphene;
b) providing fibrous carbon;
c) co grinding graphene and fibrous carbon in a high speed stirred mixer resulting to a partially ordered mixture; and
d) subjecting the partially ordered mixture to a mechanofusion.

16. The method of claim 15, wherein fibrous carbon is VGCF.

17. The method of claim 15, wherein the graphene is few layered graphene.

18. The method of claim 17, wherein the few layered graphene is Mesograf™.

19. A method to prepare a cathode material, said method comprising the steps of:
a. Providing particles of at least one lithium metal phosphate;
b. Providing fibrous carbon;
c. Providing graphene;
d. Co grinding graphene, fibrous carbon and LMP particles in a high speed stirred mixer resulting to a partially ordered mixture; and
e. subjecting the partially ordered mixture to a mechanofusion.

20. The method of claim 19, wherein the fibrous carbon is VGCF.

21. The method of claim 19 wherein the LMP is lithiumferrophospate or lithiummanganesephosphate.

22. The method of claim 19, wherein the fibrous carbon comprises carbon fibers each of which comprises fiber filaments, said fiber filaments having a diameter of 5 to 500 nm and a length to diameter ratio of 20 to 1000.
